(19) United States
(12) Patent Application Publication
(10) Pub. No.: US 2020/0250529 A1
(43) Pub. Date: Aug. 6, 2020

(54) ARITHMETIC DEVICE

(71) Applicant: Hitachi, Ltd., Tokyo (JP)

(72) Inventor: Daichi MURATA, Tokyo (JP)

(21) Appl. No.: 16/775,299

(22) Filed: Jan. 29, 2020

(30) Foreign Application Priority Data
Jan. 31, 2019 (JP) 2019-016218

(51) Int. Cl. G06N 3/08; G06N 5/04

(52) U.S. Cl. CPC G06N 3/08; G06N 5/04

(57) ABSTRACT

An arithmetic device which receives input data, a neural network, and a hyperparameter and optimizes the hyperparameter, the arithmetic device includes: a sensitivity analysis part which inputs the input data to the neural network and calculates a sensitivity to a recognition accuracy of the neural network for each of the hyperparameter; an optimization part which includes a plurality of kinds of optimization algorithms and selects the optimization algorithm according to the sensitivity to optimize the hyperparameter with the selected optimization algorithm; and a reconfiguration part which reconfigures the neural network on a basis of the optimized hyperparameter.

### CLAIM OF PRIORITY

The present application claims priority from Japanese patent application JP 2019-016218 filed on Jan. 31, 2019, the content of which is hereby incorporated by reference into this application.

### BACKGROUND OF THE INVENTION

### 1. Field of the Invention

The present invention relates to an arithmetic device using a neural network.

### 2. Description of the Related Art

As a technique for automatically recognizing an object and predicting an action, machine learning using a deep neural network (hereinafter, referred to as DNN) is known. In a case where the DNN is applied to an automatic driving vehicle, it is necessary to realize high recognition accuracy with a small DNN in consideration of the arithmetic capacity of the in-vehicle device.

In order to realize a recognition rate with high accuracy in a small scale, it is necessary to optimize the hyperparameter that determines the structure of the DNN. SigOpt, Hypernetworks, and JP 2017-162074 A are known as techniques for optimizing the DNN.

The SigOpt is a technique for stochastically searching for an optimal DNN by using Bayesian optimization. In addition, the Hypernetworks is a technique for inferring (Hyper Training) the structure of the optimal DNN with other DNNs.

JP 2017-162074 A discloses a technique in which after completing learning all optimization methods, a worker selects a layer wise grid search (LWGS), a Bayesian method, or the like to search for parameters having a recognition performance index higher than a standard.

### SUMMARY OF THE INVENTION

However, in the above-described conventional example, the SigOpt has high optimization accuracy but has a problem that the processing time increases since the number of trials increases because of the search type. In addition, in the Hypernetworks of the above embodiment, the optimization accuracy is lower than that of the SigOpt, but the processing time can be shorter than that of the SigOpt. However, the Hypernetworks has a problem that since a weighting factor for inferring the optimal DNN structure is required to be added to the DNN for optimizing the structure, the convergence of learning is reduced, and the scale of the DNN is increased.

In JP 2017-162074 A of the above-described conventional example, it is necessary to complete learning for all optimization methods. However, it takes a long time to complete learning, and thus a DNN optimization work cannot be performed quickly, which is problematic.

In this regard, the present invention has been made in view of the above problems, and an object of the invention is to improve DNN recognition accuracy while reducing a time required for optimizing a hyperparameter for determining a DNN.

An arithmetic device which receives input data, a neural network, and a hyperparameter and optimizes the hyperparameter, the arithmetic device includes:

a sensitivity analysis part which inputs the input data to the neural network and calculates a sensitivity to a recognition accuracy of the neural network for each hyperparameter; an optimization part which includes a plurality of kinds of optimization algorithms and selects the optimization algorithm according to the sensitivity to optimize the hyperparameter with the selected optimization algorithm; and a reconfiguration part which reconfigures the neural network on a basis of the optimized hyperparameter.

Therefore, according to the present invention, it is possible to improve the recognition accuracy while reducing the time required for the optimization of the neural network (DNN).

The details of at least one implementation of the subject matter disclosed herein are set forth in the accompanying drawings and the description below. Other features, aspects, and advantages of the disclosed subject matter are apparent from the following disclosure, the drawings, and the claims.

### BRIEF DESCRIPTION OF THE DRAWINGS

FIG. 1 is a block diagram illustrating an example of a DNN hyperparameter optimization device according to a first embodiment of the present invention;

FIG. 2 is a diagram illustrating an example of a processing performed by the DNN hyperparameter optimization device according to the first embodiment of this invention;

FIG. 3 is a block diagram illustrating an example of a DNN hyperparameter optimization device according to a second embodiment of the present invention;

FIG. 4 is a diagram illustrating an example of a processing performed by the DNN hyperparameter optimization device according to the second embodiment of this invention; and

FIG. 5 is a graph illustrating a relationship between an optimization processing time and DNN recognition accuracy according to the second embodiment of the present invention.

### DESCRIPTION OF THE PREFERRED EMBODIMENTS

Hereinafter, one embodiment of the present invention will be described with reference to the accompanying drawings.

### First Embodiment

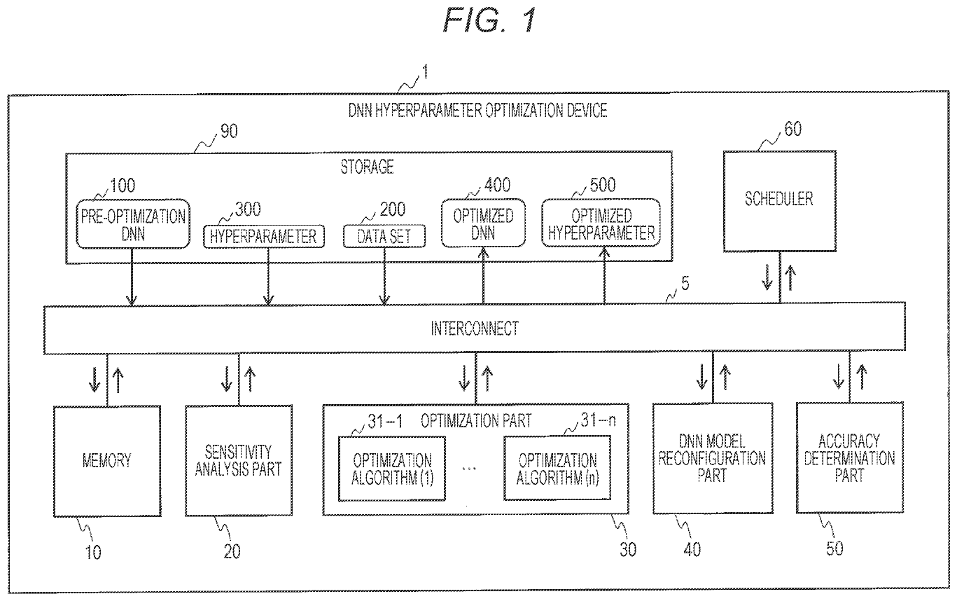

FIG. 1 is a block diagram illustrating an example of a deep neural network (DNN) hyperparameter optimization device 1 according to a first embodiment of the present invention.

The DNN hyperparameter optimization device 1 is an arithmetic device which includes a hyperparameter 300 which is an optimization target, a pre-optimization DNN 100, a storage 90 for storing a data set 200 to be input to the DNN 100, a memory 10 which holds intermediate data and the like, a sensitivity analysis part 20, an optimization part 30, a DNN model reconfiguration part 40, an accuracy determination part 50, a scheduler 60 that controls the function parts of the sensitivity analysis part 20 to the accuracy determination part 50, and an interconnect 5 that connects each part. Incidentally, for example, an advanced extensible interface (AXi) can be employed as the interconnect 5.

The optimization part 30 of the first embodiment includes a plurality of types of optimization algorithms 32-1 to 32-n in order to optimize the hyperparameter 300. Incidentally, in the following description, in a case where an optimization algorithm is not specified, a reference numeral “32” in which “-” and subsequent characters are omitted is used. The same applies to the reference numerals of other components. As the optimization algorithm 32, a known or publicly known technique can be applied. A plurality of optimization algorithms 32 have algorithms in which performances such as a processing time and neural network recognition accuracy are different from each other.

Among the components of the DNN hyperparameter optimization device 1, the memory 10 and the sensitivity analysis part 20 to the accuracy determination part 50 function as slaves, and the scheduler 60 functions as a master that controls the slaves.

In the DNN hyperparameter optimization device 1 according to the first embodiment, the function parts of the sensitivity analysis part 20 to the accuracy determination part 50 and the scheduler 60 are implemented in hardware. The DNN hyperparameter optimization device 1 can be attached to an expansion slot of a computer and exchange data, for example. Incidentally, an application specific integrated circuit (ASIC), a field programmable gate allay (FPGA), or the like can be adopted as the hardware.

In the first embodiment, an example is described in which each function part is configured by hardware, but the invention is not limited thereto. For example, a part or all of the sensitivity analysis part 20 to the scheduler 60 can be implemented by software.

The pre-optimization DNN 100 stored in the storage 90 includes a neural network, a weighting factor, and a bias. In addition, the data set 200 is data corresponding to the application (or device) to which the DNN 100 is applied and includes data with a correct answer and data without a correct answer. An optimized DNN 400 is a result of the optimization processing performed by the sensitivity analysis part 20 to the accuracy determination part 50.

The hyperparameter 300 is a parameter that includes the number of hidden layers (intermediate layers) between the input layer and the output layer, the number of neurons (or nodes) in each layer, and the like and determines the configuration of the DNN 100. In addition, the hyperparameter 300 may include a learning rate, a batch size, and the number of learning iterations. Incidentally, the hyperparameter 300 may include a plurality of hyperparameters.

The scheduler 60 receives the pre-optimization DNN 100, the hyperparameter 300, and the data set 200, executes the optimization processing of the hyperparameter 300 by controlling each of the above function parts in a preset order, and generates an optimized hyperparameter 500 and the optimized DNN 400.

In the DNN hyperparameter optimization device 1 of the first embodiment, from the input hyperparameter 300, the pre-optimization DNN 100, and the data set 200 corresponding to the application of the application destination, the hyperparameter 300 is optimized to search for the optimized hyperparameter 500. Then, the DNN hyperparameter optimization device 1 reconfigures the DNN 100 based on the optimized hyperparameter 500 to generate the optimized DNN 400.

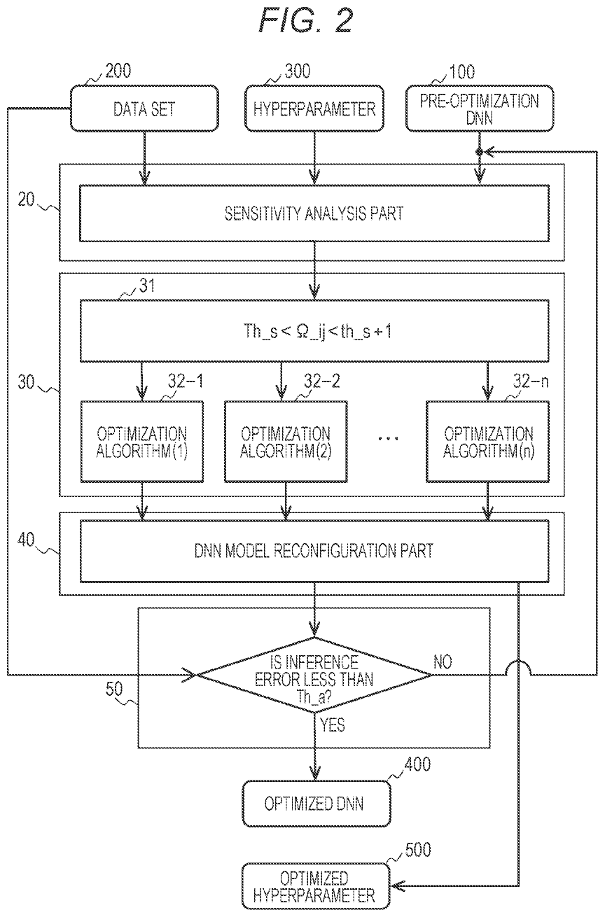

Hereinafter, the processing performed by the DNN hyperparameter optimization device 1 will be described. FIG. 2 is a diagram illustrating an example of the processing performed by the DNN optimization device.

First, the scheduler 60 inputs the pre-optimization hyperparameter 300, the pre-optimization DNN 100, and the data set 200 to the sensitivity analysis part 20. The sensitivity analysis part 20 inputs the input data of the data set 200 to the DNN 100, calculates a sensitivity Q for the recognition accuracy of the DNN 100 for each hyperparameter 300, and outputs the sensitivity to the optimization part 30. Incidentally, in the first embodiment, as an example of sensitivity analysis, an example is described in which noise is added to the data set 200, and the sensitivity to the recognition accuracy of the DNN 100 is analyzed.

Incidentally, the sensitivity analysis processing performed by the sensitivity analysis part 20 can use a known or publicly known method, and for example, “Memory Aware Synapses: Learning what (not) to forget” (R. Aljundi, et al. 2018) can be adopted.

In the sensitivity analysis processing, a minute perturbation (noise or the like) is given to the data set 200 to be input to the DNN 100, and the sensitivity Q given to the recognition accuracy of the DNN 100 is analyzed for each layer. Incidentally, the sensitivity Q may be calculated as the sensitivity (importance) to the recognition accuracy of the neurons of each neural network.

In the optimization part 30, a sensitivity determination part 31 selects any one of the n optimization algorithms 32 of a plurality of optimization algorithms 32-1 to 32-n according to the sensitivity Q output from the sensitivity analysis part 20 and analyzed for each hyperparameter 300, and performs the optimization of the hyperparameter 300.

In the first embodiment, the optimization part 30 separates the hyperparameter 300 having a high sensitivity Q with respect to the recognition accuracy of the DNN 100 and the hyperparameter 300 having a low sensitivity Q. Then, the optimization part 30 selects the optimization algorithm 32 having high recognition accuracy rather than a processing time for the hyperparameter 300 having a high sensitivity Q. On the other hand, the optimization part 30 selects the optimization algorithm 32 with a short processing time for the hyperparameter 300 having a low sensitivity Q.

For example, when n=3, the optimization part 30 selects the optimization algorithm 32-1 if the sensitivity Q is less than the threshold Th_s1, and selects the optimization algorithm 32-2 if the sensitivity Q is greater than or equal to the threshold Th_s1 and less than the threshold Th_s2, and if the sensitivity Q is equal to or greater than the threshold Th_s2, selects the optimization algorithm 32-3.

The optimization algorithm 32-1 is a method in which a recognition accuracy is not high, but a processing time is short, the optimization algorithm 32-3 is a method in which a processing time is long, but a recognition accuracy is high, and the optimization algorithm 32-2 is a method in which both are intermediate.

The optimization part 30 outputs the result of optimization performed by the optimization algorithm 32 for each hyperparameter 300 to the DNN model reconfiguration part 40. The DNN model reconfiguration part 40 generates the optimized hyperparameter 500 from the result of optimization by the optimization algorithm 32. Then, the DNN model reconfiguration part 40 reconfigures the optimized DNN candidate from the optimized hyperparameter 500 and outputs the candidate to the accuracy determination part 50.

The accuracy determination part 50 inputs the data with the correct answer of the data set 200 to the optimized DNN candidate, performs inference, and calculates an inference error. The accuracy determination part 50 determines the inference error (or inference accuracy) of the optimized DNN candidate from the inference result and the correct answer and determines whether the inference error is less than a predetermined threshold Th_a. Incidentally, for example, the inference error may be a statistical value (such as an average value) based on the reciprocal of the correct answer rate of the inference result of the DNN candidate.

If the inference error is equal to or greater than the threshold value Th_a, the accuracy determination part 50 selects the next hyperparameter 300 and repeats the above processing. On the other hand, if the inference error is less than the threshold Th_a, the accuracy determination 50 outputs the DNN candidate as the optimized DNN 500. In addition, the DNN model reconfiguration part 40 outputs, as the optimized hyperparameter 500 that satisfies the recognition accuracy, the optimized hyperparameter 500 that has generated the optimized DNN 500.

As described above, the DNN hyperparameter optimization device 1 generates the optimized hyperparameter 500 from the analysis of the DNN 100 by the sensitivity analysis part 20 and the result of the optimization of the hyperparameter 300 by the optimization part 30 and reconfigures the DNN candidate on the basis of the optimized hyperparameter 500. Then, the DNN hyperparameter optimization device 1 outputs the DNN candidate of which inference error is less than the threshold Th_a from among the DNN candidates as the optimized DNN 400, and outputs the hyperparameter obtained by reconfiguring the DNN 400 as the optimized hyperparameter 500.

In the first embodiment, the DNN hyperparameter optimization device 1 inputs the hyperparameter 300, the DNN 100, and the data set 200, and performs the analysis of sensitivity Q for the recognition accuracy of each neuron configuring the DNN 100 by the data set 200 that is given a minute perturbation as noise before learning the DNN 100, and selects the optimization algorithm 32 corresponding to the sensitivity Q to perform optimization for each hyperparameter 300.

In this way, prior to the learning of the DNN 100, the optimization of the hyperparameter 300 is performed according to the sensitivity of the recognition accuracy, whereby the recognition accuracy of the optimized DNN 400 can be improved while the time required for optimization of the hyperparameter 300 is reduced.

### Second Embodiment

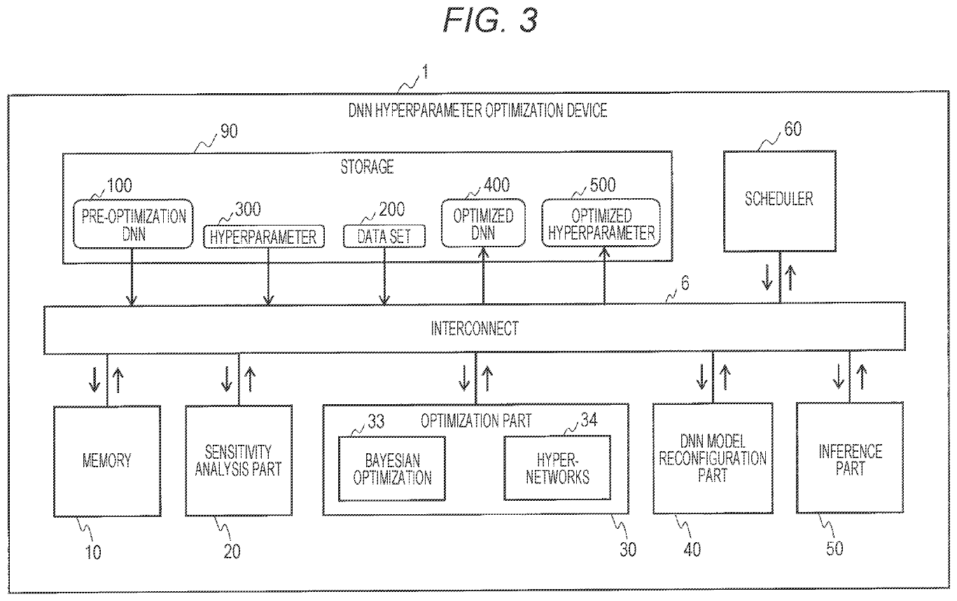

FIG. 3 illustrates a second embodiment and is a block diagram illustrating an example of the DNN hyperparameter optimization device 1. The DNN hyperparameter optimization device 1 of the second embodiment employs two methods of Bayesian optimization 33 and Hypernetworks 34 as the optimization algorithm 32 of the optimization part 30 and selects the method according to the sensitivity Q. Other configurations are the same as those in the first embodiment.

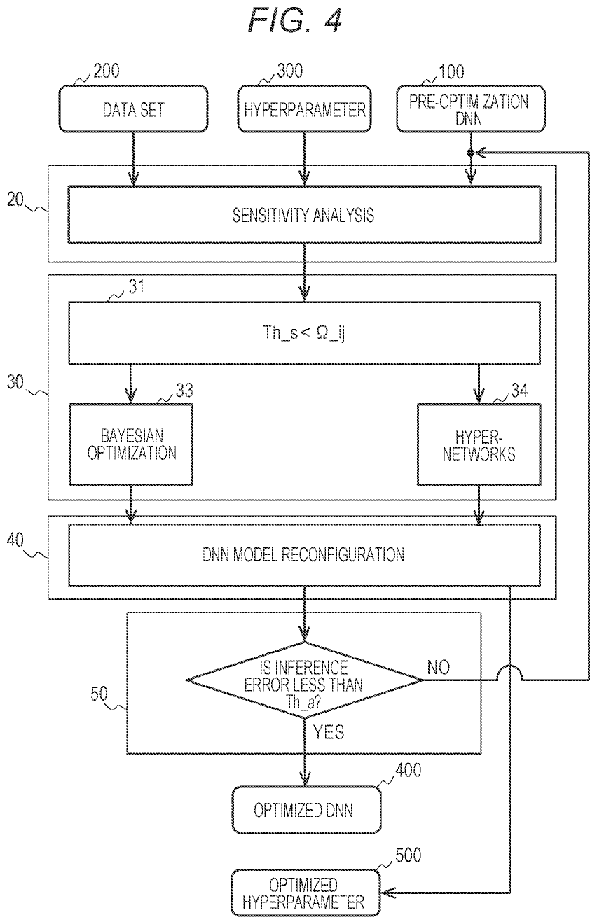

FIG. 4 is a diagram illustrating an example of the processing performed in the DNN hyperparameter optimization device 1. In the DNN hyperparameter optimization device 1, as in the first embodiment, the sensitivity analysis part 20 calculates the sensitivity Q of the neural network for each hyperparameter 300 and outputs the sensitivity to the optimization part 30.

In the optimization part 30, the sensitivity determination part 31 selects an optimization algorithm that optimizes the hyperparameter 300 according to the comparison result between the predetermined threshold Th_s and the sensitivity Q. In the second embodiment, when the sensitivity Q is larger than the threshold value Th_s, the sensitivity determination part 31 selects the Bayesian optimization 33 and performs the optimization of the hyperparameter 300. On the other hand, when the sensitivity Q is equal to or less than the threshold value Th_s, the sensitivity determination part 31 selects the Hypernetworks 34 and optimizes the hyperparameter 300.

Here, the Bayesian optimization 33 is employed in the SigOpt of conventional technique, which is excellent in recognition accuracy and learning convergence of the DNN 400 but requires a long processing time. For example, “Freeze-Thaw Bayesian Optimization” can be employed as the Bayesian optimization 33 of the second embodiment.

On the other hand, the Hypernetworks 34 is known as “Stochastic Hyperparameter Optimization through Hypernetworks” (J. Lorraine, et al., 2018). The Hypernetworks 34 can reduce the processing time compared to the Bayesian optimization 33, but the recognition accuracy is reduced.

In the optimization part 30 of the second embodiment, for the hyperparameter 300 of which the sensitivity Q to recognition accuracy is higher than the threshold Th_s, the Bayesian optimization 33 is selected to improve the recognition accuracy of the optimized DNN 400 over the processing time. On the other hand, for the hyperparameter 300 of which the sensitivity Q to recognition accuracy is equal to or less than the threshold value Th_s, the Hypernetworks 34 is selected to shorten the processing time.

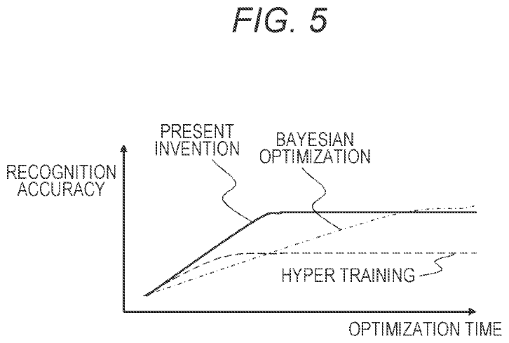

FIG. 5 is a graph illustrating the relationship between the optimization processing time and the DNN recognition accuracy. A solid line in the drawing indicates the relationship between the processing time (optimization time) of the optimization of the hyperparameter 300 by the DNN hyperparameter optimization device 1 of the second embodiment and the recognition accuracy of the optimized DNN 400. A one-dot chain line in the drawing indicates the relationship between the processing time by the Bayesian optimization 33 and the accuracy determination. A broken line in the drawing indicates the relationship between the processing time by the Hypernetworks 34 and the accuracy determination.

In the optimization processing by the DNN hyperparameter optimization device 1 of the second embodiment, the same recognition accuracy can be ensured similarly with that of the Bayesian optimization 33 as well as the process can be performed in a shorter time than the Bayesian optimization 33.

As described above, in the optimization part 30 of the second embodiment, when the optimization processing of the hyperparameters having different tendency of recognition accuracy and processing time is performed according to the sensitivity Q with respect to the recognition accuracy of the hyperparameter 300, the recognition accuracy of the optimized DNN 400 can be improved while the processing time required for the optimization is reduced.

Incidentally, in the second embodiment, an example is described in which two optimization methods are switched according to the sensitivity Q. However, the present invention is not limited thereto, and many kinds of optimization methods may be selected according to the range of the sensitivity Q.

In the second embodiment, the Bayesian optimization 33 is employed as the optimization algorithm 32 that maximizes the recognition accuracy, and the Hypernetworks 34 is employed as the optimization algorithm 32 that minimizes the processing time. However, the present invention is not limited thereto. The optimization algorithm 32 may include the optimization algorithm 32 that maximizes recognition accuracy and the optimization algorithm 32 that minimizes the optimization processing time.

### SUMMARY

As described above, the devices of the first to third embodiments can be configured as follows.

(1) An arithmetic device (DNN hyperparameter optimization device 1) which receives input data (data set 200), a neural network (pre-optimization DNN 100), and a hyperparameter (300) and optimizes the hyperparameter (300). The arithmetic device includes: a sensitivity analysis part (20) which inputs the input data (200) to the neural network (100) and calculates a sensitivity (Q) to a recognition accuracy of the neural network (100) for each hyperparameter (300); an optimization part (30) which includes a plurality of kinds of optimization algorithms (32) and selects the optimization algorithm (32) according to the sensitivity (Q) to optimize the hyperparameter (300) with the selected optimization algorithm (32); and a reconfiguration part (DNN model reconfiguration part 40) which reconfigures the neural network on a basis of the optimized hyperparameter (optimized hyperparameter 500).

With the above configuration, the DNN hyperparameter optimization device 1 performs the analysis of sensitivity Q for the recognition accuracy of each neuron configuring the DNN 100 by the data set 200 that is given a minute perturbation before learning the DNN 100, and selects the optimization algorithm 32 corresponding to the sensitivity Q to perform optimization for each hyperparameter 300. In this way, the optimization of the hyperparameter 300 is performed according to the sensitivity of the recognition accuracy, whereby the recognition accuracy can be improved while the time required for optimization of the hyperparameter 300 is reduced.

(2) The arithmetic device (1) according to (1) further includes: an accuracy determination part (50) which gives the input data (200) to the reconfigured neural network and performs inference to calculate an inference error, and outputs a neural network in which the inference error is less than a predetermined first threshold (Th_a) as an optimized neural network (optimized DNN 400).

With the above configuration, the DNN hyperparameter optimization device 1 can output a neural network of which the inference error is less than the first threshold (Th_a) as the optimized DNN 400 and output the hyperparameter corresponding to the optimized DNN 400 as the optimized hyperparameter 500.

(3) In the arithmetic device (1) according to (2), the accuracy determination part (50) repeats processing of the sensitivity analysis part (20), the optimization part (30), and the reconfiguration part (40) when the inference error is equal to or greater than the first threshold (Th_a).

With the above configuration, the DNN hyperparameter optimization device 1 can repeatedly perform the optimization of the hyperparameter until the inference error is less than the first threshold (Th_a) and output the hyperparameter 300 and the DNN 400 with the maximum inference accuracy.

(4) The arithmetic device (1) according to (2), further includes: a memory (10) which temporarily stores intermediate data in a middle of calculation of the sensitivity analysis part (20), the optimization part (30), the reconfiguration part (40) and the accuracy determination part (50); a scheduler (60) as a master for controlling slaves which are the sensitivity analysis part (20), the optimization part (30), the reconfiguration part (40), the accuracy determination part (50), and the memory (10); and an interconnect (5) which connects the master and the slaves.

With the above configuration, the DNN hyperparameter optimization device 1 is configured by hardware, so that the optimization processing of the hyperparameter 300 can be accelerated.

(5) In the arithmetic device according to (1), the optimization part (30) includes a plurality of different kinds of optimization algorithms (32) and selects any one of the plurality of optimization algorithms (32) according to a range of the sensitivity (Q).

With the above configuration, when many different kinds of optimization algorithms 32 are prepared, the DNN hyperparameter optimization device 1 can select the optimization algorithm 32 according to sensitivity Q and realize the optimization according to sensitivity Q.

(6) In the arithmetic device (1) according to (1), the optimization part (30) includes Bayesian optimization (33) and Hypernetworks (34) as the optimization algorithm (32), and selects the Bayesian optimization (33) when the sensitivity (Q) is greater than a predetermined second threshold (Th_s) and selects the Hypernetworks (34) when the sensitivity is equal to or less than the second threshold (Th_s).

With the above configuration, the DNN hyperparameter optimization device 1 selects the Bayesian optimization 33 to perform the optimization with high recognition accuracy when sensitivity Q is greater than the second threshold (Th_s) and selects the Hypernetworks 34 to perform the optimization with short processing time when the sensitivity Q is equal or less than the second threshold (Th_s), thereby realizing the optimization processing with high recognition accuracy and short processing time.

(7) In the arithmetic device (1) according to (1), the optimization part (30) includes a first optimization algorithm (32) that maximizes the recognition accuracy of the neural network reconfigured from the optimized hyperparameter (500) and a second optimization algorithm (32) that minimizes processing time of the optimization.

With the above configuration, the DNN hyperparameter optimization device 1 optimizes the hyperparameter 300 using the first optimization algorithm 32 that maximizes recognition accuracy when the hyperparameter 300 has a high sensitivity Q and optimizes the hyperparameter 300 using the first optimization algorithm 32 when the hyperparameter 300 has a low sensitivity Q. As a result, it is possible to realize optimization that maximizes recognition accuracy and minimizes processing time.

Incidentally, this present invention is not limited to the above-described embodiments, and various modifications are included. For example, the above-described embodiments have been described in detail for easy understanding of the invention and are not necessarily limited to those having all the described configurations. Further, a part of the configuration of one embodiment can be replaced with the configuration of another embodiment, and the configuration of another embodiment can be added to the configuration of one embodiment. In addition, any of the additions, deletions, or substitutions of other configurations can be applied to a part of the configuration of each embodiment, either alone, or in combination.

Each of the above-described configurations, functions, processing parts, processing means, and the like may be realized by hardware by designing a part or all of them with, for example, an integrated circuit. In addition, each of the above-described configurations, functions, and the like may be realized by software by the processor interpreting and executing a program that realizes each function. Information such as programs, tables, and files that realize each function can be stored in a recording device such as a memory, a hard disk, or an SSD (Solid State Drive), or a recording medium such as an IC card, an SD card, or a DVD.

Further, control lines and information lines indicate what is considered to be necessary for the description, and not all control lines and information lines in the product are necessarily illustrated. Actually, it may be considered that almost all the components are connected to each other.

What is claimed is:

1. An arithmetic device which receives input data, a neural network, and a hyperparameter and optimizes the hyperparameter, the arithmetic device comprising:
a sensitivity analysis part which inputs the input data to the neural network and calculates a sensitivity to a recognition accuracy of the neural network for each hyperparameter;
an optimization part which includes a plurality of kinds of optimization algorithms and selects the optimization algorithm according to the sensitivity to optimize the hyperparameter with the selected optimization algorithm; and
a reconfiguration part which reconfigures the neural network on a basis of the optimized hyperparameter.

2. The arithmetic device according to claim 1, further comprising:
an accuracy determination part which gives the input data to the reconfigured neural network and performs inference to calculate an inference error, and outputs a neural network in which the inference error is less than a predetermined first threshold as an optimized neural network.

3. The arithmetic device according to claim 2, wherein
the accuracy determination part repeats processing of the sensitivity analysis part, the optimization part, and the reconfiguration part when the inference error is equal to or greater than the first threshold.

4. The arithmetic device according to claim 2, further comprising:
a memory which temporarily stores intermediate data in a middle of calculation of the sensitivity analysis part, the optimization part, the reconfiguration part and the accuracy determination part;
a scheduler as a master for controlling slaves which are the sensitivity analysis part, the optimization part, the reconfiguration part, the accuracy determination part, and the memory; and
an interconnect which connects the master and the slaves.

5. The arithmetic device according to claim 1, wherein
the optimization part includes a plurality of different kinds of optimization algorithms and selects any one of the plurality of optimization algorithms according to a range of the sensitivity.

6. The arithmetic device according to claim 1, wherein
the optimization part includes Bayesian optimization and Hypernetworks as the optimization algorithm, and selects the Bayesian optimization when the sensitivity is greater than a predetermined second threshold and selects the Hypernetworks when the sensitivity is equal to or less than the second threshold.

7. The arithmetic device according to claim 1, wherein
the optimization part includes a first optimization algorithm that maximizes the recognition accuracy of the neural network reconfigured from the optimized hyperparameter and a second optimization algorithm that minimizes processing time of the optimization.
